(19) United States
(12) Patent Application Publication
(10) Pub. No.: US 2024/0149924 A1
(43) Pub. Date: May 9, 2024

(54) CONTROL APPARATUS FOR HYBRID ELECTRIC VEHICLE

(71) Applicant: TOYOTA JIDOSHA KABUSHIKI KAISHA, Toyota-shi Aichi-ken (JP)

(72) Inventor: Takanori IGARASHI, Toyota-shi Aichi-ken (JP)

(73) Assignee: TOYOTA JIDOSHA KABUSHIKI KAISHA, Toyota-shi Aichi-ken (JP)

(21) Appl. No.: 18/498,436

(22) Filed: Oct. 31, 2023

(30) Foreign Application Priority Data
Nov. 4, 2022 (JP) 2022-177680

(51) Int. Cl. B60W 60/00; B60W 10/08; B60W 10/26; B60W 20/10

(52) U.S. Cl. CPC B60W 60/0053; B60W 10/08; B60W 10/26; B60W 20/10; B60W 2510/244

(57) ABSTRACT

A control apparatus for a hybrid electric vehicle includes an engine, an electric motor, and a battery that supplies and receives an electric power to and from the electric motor. The control apparatus includes (a) a driving control portion configured to execute an manual driving control for driving the vehicle based on a driving operation by a driver of the vehicle and an autonomous driving control for driving the vehicle by automatically performing steering and acceleration/deceleration of the vehicle; and (b) a charging control portion configured to perform an NV suppression control in which a required charging power for charging the battery with the electric power generated by the electric motor using a power of the engine, is set to a larger value during an unmanned driving in the autonomous driving control than during a manned driving in the autonomous driving control.

### CROSS-REFERENCE TO RELATED APPLICATION

This application claims priority from Japanese Patent Application No. 2022-177680 filed on Nov. 4, 2022, the disclosure of which is herein incorporated by reference in its entirety.

### FIELD

The present disclosure relates to a control apparatus for a hybrid electric vehicle including an engine and an electric motor.

### BACKGROUND

A control apparatus for a hybrid electric vehicle including an engine, an electric motor, and a battery for supplying and receiving an electric power to and from the electric motor is well known. For example, a driving control device for a hybrid electric vehicle described in Patent Document 1 is one of such apparatuses. Patent Document 1 discloses that a driving mode includes an HEV driving mode in which the vehicle can run using power of both the engine and the electric motor, and a BEV driving mode in which the vehicle runs using only power of the electric motor. Further, Patent Document 1 discloses that the BEV driving mode is adopted when the remaining charge amount of the battery is sufficiently large, and the HEV driving mode is adopted when the remaining charge amount is lower than a predetermined threshold value. Further, Patent Document 1 discloses that the engine is operated in a state where an operating point of the engine is positioned on a fuel efficiency optimum line in the HEV driving mode. Further, Patent Document 1 discloses that the driving control includes a manual driving control for driving the vehicle based on a driving operation of a vehicle driver and an autonomous driving control for driving the vehicle by automatically performing steering and acceleration/deceleration.

### PRIOR ART DOCUMENTS

### Patent Documents

### Patent Document 1

Japanese Unexamined Patent Application Publication No. 2018-43544

### SUMMARY

Incidentally, as disclosed in Patent Document 1, in a hybrid electric vehicle, when an operating point of an engine is determined so as to optimize energy efficiency, a rotational speed of the engine may be increased. On the other hand, during the execution of an autonomous driving, since the driving operation by the vehicle driver is not performed, compared to during the execution of a manual driving, a so-called NV may be increased due to the switching between the start and stop of the engine or the fluctuation between the increase and decrease of the rotational speed of the engine. In the autonomous driving, there is room for improvement in performance against the NV, i.e., NV performance, of suppressing increase of the NV. The “autonomous driving” is a driving under the autonomous driving control. The “manual driving” is a driving under the manual driving control. The “NV” is a general term for noise and vibration generated in the vehicle and represents at least one of noise and vibration in the vehicle. The autonomous driving includes a manned autonomous driving in which at least one of a vehicle driver, an owner, a user, a fellow passenger, an occupant, a passenger, and the like is on board, and an unmanned autonomous driving in which none of the driver, the fellow passenger, the occupant, the passenger, and the like is on board. The “manned autonomous driving” is a manned driving in the autonomous driving control. The “unmanned autonomous driving” is an unmanned driving in the autonomous driving control.

The present disclosure has been made in view of the above circumstances, and an object thereof is to provide a control apparatus for a hybrid electric vehicle, which is capable of improving NV performance in an autonomous driving. This object is achieved according to the present disclosure.

According the disclosure, there is provided a control apparatus for a hybrid electric vehicle includes an engine, an electric motor, and a battery that supplies and receives an electric power to and from the electric motor. The control apparatus includes (a) a driving control portion configured to execute an manual driving control for driving the vehicle based on a driving operation by a driver of the vehicle and an autonomous driving control for driving the vehicle by automatically performing steering and acceleration/deceleration of the vehicle; and (b) a charging control portion configured to perform an NV suppression control in which a required charging power for charging the battery with the electric power generated by the electric motor using a power of the engine, is set to a larger value during an unmanned driving in the autonomous driving control than during a manned driving in the autonomous driving control.

According to the present disclosure, during execution of unmanned autonomous driving, the NV suppression control is performed to set the required charging power to a larger value than during execution of manned autonomous driving. Accordingly, the charging power to the battery is increased during the execution of the unmanned autonomous driving in which the increase of the NV is less likely to be a problem, and a remaining charge amount of the battery upon start of the manned autonomous driving switched from the unmanned autonomous driving is increased as compared with that during the continuation of the manned autonomous driving. Therefore, in a period in which the remaining charge amount of the battery is large after the start of the manned autonomous driving after the transition from the unmanned autonomous driving, the time during which the engine is in the stop state is increased or the rotational speed of the engine is reduced. Therefore, the NV performance can be improved in the autonomous driving.

### BRIEF DESCRIPTION OF THE DRAWINGS

FIG. 1 is a diagram illustrating a schematic configuration of a vehicle to which the present disclosure is applied, and is a diagram illustrating a control function and a main part of a control system for various types of control in the vehicle;

FIG. 2 is a flowchart illustrating a main part of a control operation of an electronic control apparatus, and is a flowchart illustrating a control operation for improving NV performance in an autonomous driving; and

FIG. 3 is a diagram showing an example of a time chart when the control operation shown in the flowchart of FIG. 2 is executed.

### DETAILED DESCRIPTION

Embodiments of the present disclosure will be described in detail below with reference to the drawings.

### Embodiment

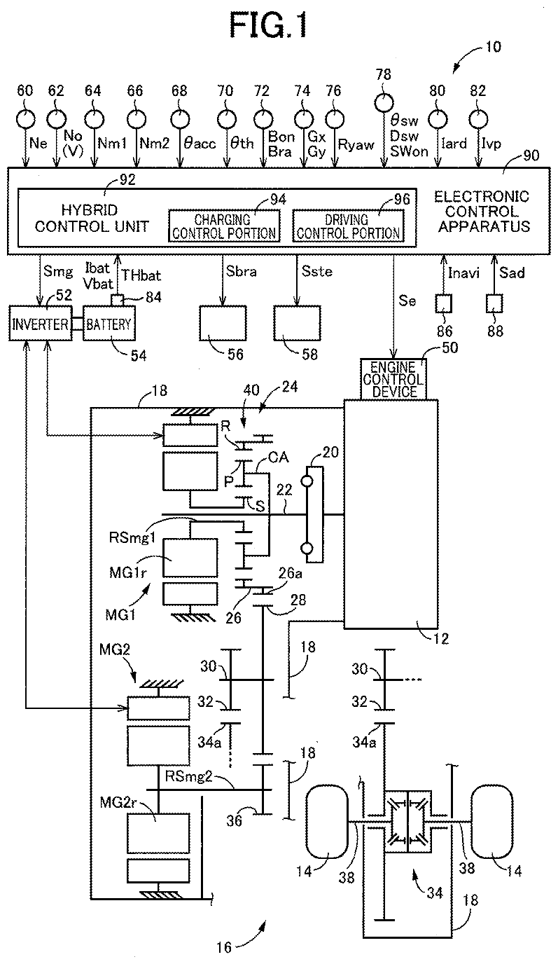

FIG. 1 is a diagram illustrating a schematic configuration of a vehicle 10 to which the present disclosure is applied, and is a diagram illustrating a main part of a control system for various controls in the vehicle 10. In FIG. 1, the vehicle 10 is a hybrid electric vehicle including an engine 12 and a first motor MG1 and a second motor MG2 as motors. The engine 12 and the second motor MG2 function as power sources SP for driving the vehicle 10. The vehicle 10 also includes drive wheels 14 and a power transmission device 16 provided in a power transmission path between the engine 12 and the drive wheels 14.

The engine 12 is a known internal combustion engine. In the engine 12, an engine torque Te which is a torque of the engine 12 is controlled by an engine control device 50 provided in the vehicle 10 and controlled by an electronic control apparatus 90 which will be described later.

The first motor MG1 and the second motor MG2 are rotary electric machines, and are so-called motor generators. The first motor MG1 and the second motor MG2 are connected to a battery 54 provided in the vehicle 10 via an inverter 52 provided in the vehicle 10. The battery 54 is a power storage device that supplies and receives an electric power to and from each of the first motor MG1 and the second motor MG2. Each of the first motor MG1 and the second motor MG2 is controlled with the inverter 52 being controlled by the electronic control apparatus 90, which will be described later, so that an MG1 torque Tm1, which is a torque of the first motor MG1, and an MG2 torque Tm2, which is a torque of the second motor MG2, are controlled. The first motor MG1 and the second motor MG2 are provided in a case 18 as a non-rotating member attached to a body of the vehicle 10.

The power transmission device 16 includes, in the case 18, a damper 20, an input shaft 22, a transmission portion 24, a composite gear 26, a driven gear 28, a driven shaft 30, a final gear 32, a differential gear device 34, and a reduction gear 36. The power transmission device 16 includes a rotor shaft RSmg1 integrally connected to a rotor MG1r of the first motor MG1 and a rotor shaft RSmg2 integrally connected to a rotor MG2r of the second motor MG2 in the case 18. The power transmission device 16 also includes a pair of drive shafts 38 coupled to the differential gear device 34.

A drive gear 26a is formed on a part of an outer peripheral surface of the composite gear 26. The driven gear 28 meshes with the drive gear 26a. The driven gear 28 and the final gear 32 are fixedly mounted on the driven shaft 30, so as to be unrotatable relative to each other. The final gear 32 meshes with a differential ring gear 34a of the differential gear device 34. The rotor shaft RSmg2 is coupled to the reduction gear 36, and the second motor MG2 is coupled to the reduction gear 36 in a power transmittable manner.

The transmission portion 24 includes the first motor MG1, the rotor shaft RSmg1 and a planetary gear device 40. The planetary gear device 40 is a known single-pinion planetary gear device including a sun gear S, a carrier CA, a ring gear R, and a pinion P. The planetary gear device 40 functions as a differential mechanism that produces a differential action. The planetary gear device 40 is a power distribution mechanism that mechanically distributes the power of the engine 12 to the first motor MG1 and the drive gear 26a. The transmission portion 24 is a known electric continuously variable transmission in which a differential state of the planetary gear device 40 is controlled by controlling an operation state of the first motor MG1.

The vehicle 10 includes the electronic control apparatus 90 as a controller including a control apparatus of the vehicle 10 related to control of the engine 12, for example. The electronic control apparatus 90 includes, for example, a so-called microcomputer including a CPU, a RAM, a ROM and an input/output interface. The electronic control apparatus 90 performs various controls of the vehicle 10 by the CPU performing signal processing in accordance with a program stored in advance in the ROM while using a temporary storage function of the RAM.

The electronic control apparatus 90 is supplied with various signals based on values detected by various sensors or the like provided in the vehicle 10, wherein the various sensors or the like include an engine speed sensor 60, an output speed sensor 62, an MG1 speed sensor 64, an MG2 speed sensor 66, an accelerator opening degree sensor 68, a throttle-valve opening degree sensor 70, a brake pedal sensor 72, a G sensor 74, a yaw rate sensor 76, a steering sensor 78, a vehicle-area information sensor 80, a vehicle position sensor 82, a battery sensor 84, a navigation system 86 and an autonomous-driving selection switch 88, and wherein the various signals include a signal indicative of an engine rotational speed Ne, a signal indicative of an output rotational speed No, a signal indicative of an MG1 rotational speed Nm1, a signal indicative of an MG2 rotational speed Nm2, a signal indicative of an accelerator opening degree θacc, a signal indicative of a throttle-valve opening degree θth, a brake-ON signal Bon, a signal indicative of a brake operation amount Bra, a signal indicative of a longitudinal acceleration Gx, a signal indicative of a lateral acceleration Gy, a signal indicative of a yaw rate Ryaw, a signal indicative of a steering angle θsw, a signal indicative of a steering direction Dsw, a steering-ON signal SWon, a signal indicative of a vehicle-area information lard, a signal indicative of a position information Ivp, a signal indicative of a battery temperature THbat, a signal indicative of a battery charge/discharge current Ibat, a signal indicative of a battery voltage Vbat, a signal indicative of a navigation information Inavi and an autonomous-driving setting signal Sad.

The engine rotational speed Ne is a rotational speed of the engine 12. The output rotational speed No is a rotational speed of the drive gear 26a, and corresponds to a vehicle speed V that is a running speed of the vehicle 10. The MG1 rotational speed Nm1 is the rotational speed of the first motor MG1. The MG2 rotational speed Nm2 is the rotational speed of the second motor MG2. The accelerator opening degree θacc represents a magnitude or amount of an acceleration operation by a vehicle driver. The throttle-valve opening degree θth is an opening degree of an electronic throttle valve. The brake-ON signal Bon is a signal indicative of a state in which a brake pedal for operating a wheel brake is operated by the vehicle driver. The brake operation amount Bra represents a magnitude or amount of a brake operation by the vehicle driver. The steering angle θsw is a steering angle of a steering wheel. The steering direction Dsw is a steering direction of the steering wheel. The steering-ON signal SWon is a signal indicative of a state in which the steering wheel is gripped by the vehicle driver. The autonomous-driving setting signal Sad is a signal indicative of a setting by the vehicle driver in an autonomous driving control CTad.

The vehicle-area information sensor 80 includes, for example, at least one of a LIDAR, a radar, an in-vehicle camera, and the like. The vehicle-area information sensor 80 detects an object in front of the vehicle 10, an object on sides of the vehicle 10, an object behind the vehicle 10, and the like, and outputs an object information related to the detected objects as the vehicle-area information lard.

The vehicle position sensor 82 includes a GPS antenna and the like. The position information Ivp includes a vehicle position information that is information indicative of a current position of the vehicle 10 on a ground or on a map based on a global positioning system (GPS) signal (orbit signal) transmitted by a GPS satellite or the like.

The navigation system 86 is a known navigation system. The navigation information Inavi includes map information such as road information and facility information based on map information stored in advance in the navigation system 86.

The autonomous-driving selection switch 88 is a switch operated by the vehicle driver when the autonomous driving control CTad is executed.

The electronic control apparatus 90 outputs various command signals (for example, an engine control command signal Se for controlling the engine 12, a motor control command signal Smg for controlling the first and second motors MG1 and MG2, a brake control command signal Sbra for controlling the wheel brakes, and a steering control command signal Sste for controlling the steering of front wheels such as the drive wheels 14 to devices which are provided in the vehicle 10 and which include the engine control device 50, the inverters 52, a wheel brake device 56, and a steering device 58.

The wheel brake device 56 includes a brake master cylinder for generating a brake hydraulic pressure (not shown) and a cylinder actuator (not shown). Each of wheels including the drive wheel 14 is provided with a wheel brake (not shown). The wheel brake device 56 is a brake device that is controlled by the electronic control apparatus 90 to cause the wheel brake to apply a braking torque to the wheel. The wheel brake device 56 normally supplies a master cylinder hydraulic pressure as a brake hydraulic pressure having a magnitude corresponding to the brake operation amount Bra, to the wheel cylinder. On the other hand, for example, when the autonomous driving control CTad is executed, the wheel brake device 56 supplies the brake hydraulic pressure having the magnitude corresponding to a required braking torque, to the wheel cylinder.

The steering device 58 applies an assist torque corresponding to, for example, the vehicle speed V, the steering angle θsw, the steering direction Dsw, the yaw rate Ryaw, to a steering system of the vehicle 10. The steering device 58 applies a torque for controlling a steering of the front wheels, to the steering system of the vehicle 10, for example, when the autonomous driving control CTadis executed.

The electronic control apparatus 90 includes a hybrid control means, that is, a hybrid control unit 92 in order to realize various controls in the vehicle 10.

The hybrid control unit 92 has an engine control function for controlling the operation of the engine 12 and a motor control function for controlling the operation of the first motor MG1 and the second motor MG2 via the inverters 52.

The hybrid control unit 92 calculates a drive request amount, for example, a request drive torque Trdem [Nm] by applying the accelerator opening degree θacc and the vehicle speed V to a predetermined drive request amount map. In other words, the required driving torque Trdem is a required driving power Prdem [W] at the vehicle speed V at that time. The hybrid control unit 92 outputs the engine control command signal Se and the motor control command signal Smg so as to realize the required drive power Prdem in consideration of, for example, a transmission loss, an auxiliary load and a state of charge SOC of the battery 54. For example, when the transmission portion 24 is operated as a continuously variable transmission, the engine control command signal Se is a command value of the engine power Pe in consideration of an engine optimum fuel consumption point and the like. The engine power Pe is the power of the engine 12. The motor control command signal Smg is a command value of a generated electric power Wm1 of the first motor MG1 that outputs the MG1 torque Tm1 as a reaction torque of the engine torque Te when the transmission portion 24 is operated as the continuously variable transmission. The motor control command signal Smg is a command value of a consumed power Wm2 of the second motor MG2 that outputs the MG2 torque Tm2. The engine optimum fuel consumption point is determined in advance as an engine operating point at which a total fuel consumption of the vehicle 10 is minimized, in consideration of, for example, the fuel consumption of the engine 12 alone and a transmission efficiency of the power transmission device 16, that is, an optimum engine operating point. The engine operating point is an operating point represented by a rotational speed and a torque, and the engine operating point is an operating point of the engine 12 represented by the engine rotational speed Ne and the engine torque Te.

The hybrid control unit 92 calculates the state of charge SOC [%] based on, for example, the battery charge/discharge current Ibat and the battery voltage Vbat. The state of charge SOC is a state of charge of the battery 54 and is a value indicative of the state of charge of the battery 54. The hybrid control unit 92 calculates a chargeable electric power Win [W] and a dischargeable electric power Wout [W] of the battery 54 based on, for example, the battery temperature THbat and the state of charge SOC.

The hybrid control unit 92 selectively establishes a BEV driving mode or an HEV driving mode as a driving mode, depending on a running state of the vehicle 10. The BEV driving mode is a driving mode in which the vehicle 10 runs using the second motor MG2 as the power source SP in a state where the operation of the engine 12 is stopped. The BEV driving is a motor driving in which the vehicle 10 runs using only the power from the second motor MG2. In the BEV driving mode, the MG2 torque Tm2 corresponding to the required drive torque Trdem is transmitted to the drive wheels 14. The HEV driving mode is a driving mode in which the vehicle 10 runs using at least the engine 12 as the power source SP. The HEV driving is a hybrid driving in which the vehicle runs using at least the power from the engine 12, that is, engine running. In the HEV driving mode, a combined torque, which is a sum of an engine direct torque Td and the MG2 torque Tm2 and which is dependent on the required drive torque Trdem, is transmitted to the drive wheels 14. The engine direct torque Td is a positive torque that acts on the ring gear R, when the MG1 torque Tm1 of the first motor MG1, which is a negative torque acting as a reaction torque against the engine torque Te inputted as a positive torque to the carrier CA, is input to the sun gear S.

The hybrid control unit 92 establishes the BEV driving mode when the required drive power Prdem is in a BEV driving region that is smaller than a predetermined value. On the other hand, the hybrid control unit 92 establishes the HEV driving mode when the required drive power Prdem is in a HEV drive region that is equal to or greater than the predetermined value. In the HEV driving mode, the hybrid control unit 92 can perform a control to set the engine operating point to the engine optimum fuel consumption point. On the other hand, even when the required drive power Prdem is in the BEV driving region, the hybrid control unit 92 establishes the HEV driving mode when the battery 54 needs to be charged or when the engine 12 and the like need to be warmed up.

The hybrid control unit 92 includes a charging control means, that is, a charging control portion 94 in order to maintain the state of charge SOC at an appropriate value. In the vehicle 10, the battery 54 can be discharged by a power running performed by the first motor MG1 or the second motor MG2, and the battery 54 can be charged by a power generation performed by the first motor MG1 or the second motor MG2. The power generation performed by the first motor MG1 is a power generation using the power of the engine 12, and the power generation performed by the second motor MG2 is a power generation using a driven torque transmitted from the drive wheels 14.

The charging control portion 94 performs a state-of charge keeping control CTsoc for keeping the state of charge (remaining charge) SOC within a predetermined state-of-charge range (predetermined remaining charge amount range) RNGsoc by repeatedly discharge and charge the battery 54. The predetermined state-of-charge range RNGsoc is, for example, a predetermined appropriate range of the state of charge SOC for maintaining the capability of the battery 54.

The case where the battery 54 needs to be charged is, for example, a case where the state of charge SOC is lower than the predetermined state-of-charge range RNGsoc. Alternatively, the case where the charging of the battery 54 is necessary is, for example, a case where the state of charge SOC is within the predetermined state-of-charge range RNGsoc, but an energy efficiency of the vehicle 10 is improved by charging the battery 54.

The charging control portion 94 calculates a required charging power Pchgdem, which is a required value of a charging power Pchg [W] for charging the battery 54 by the power generation performed by the first motor MG1 using the power of the engine 12, such that the required charging power Pchgdem is calculated based on, for example, a difference between a target value of the state of charge SOC and a current state of charge SOCr. The current state of charge SOCr is a current value of the state of charge SOC. When the battery 54 needs to be charged, the charging control portion 94 outputs a command for realizing the required charging power Pchgdem, to the hybrid control unit 92. When the battery 54 needs to be charged during the HEV running, the engine power Pe is increased by an amount required for charging the battery 54. When the battery 54 needs to be charged during the BEV driving, the engine 12 is started to output the engine power Pe for realizing the required charging power Pchgdem.

The hybrid control unit 92 includes a driving control means, that is, a driving control portion 96 in order to perform each of a manual driving control CTmd and the above-described autonomous driving control CTad. The drive request amount based on the accelerator opening degree θ acc and the like described above is a drive request amount for the vehicle 10 requested by the vehicle driver at the time of the manual driving control CTmd. At the time of the autonomous driving control CTad, the driving control portion 96 calculates the driving request amount for the vehicle 10 requested by the autonomous driving control CTad.

The driving control portion 96 executes each of the manual driving control CTmd and the autonomous driving control CTad as driving control of the vehicle 10. The manual driving control CTmd is driving control for driving the vehicle 10 based on the driving operation of the vehicle driver. The autonomous driving control CTad is driving control for driving the vehicle 10 by automatically performing steering and acceleration/deceleration regardless of the driving operation of the driver. The acceleration and deceleration includes braking.

When the autonomous-driving selection switch 88 is turned off, the driving control portion 96 establishes a manual driving mode and executes the manual driving control CTmd. The driving control portion 96 executes the manual driving control CTmd by outputting a command for controlling each of the engine 12, the first motor MG1, the second motor MG2 and the like, to the hybrid control unit 92 in accordance with, for example, a vehicle driver's operation or the like.

When the autonomous-driving selection switch 88 is turned on, the driving control portion 96 establishes the autonomous driving mode and executes the autonomous driving control CTad. The driving control portion 96 automatically sets a target driving state based on, for example, a destination, the vehicle position information based on the position information Ivp, the map information based on the navigation information Inavi or the like, and various kinds of information on a driving road based on the vehicle-area information lard. The driving control portion 96 performs the autonomous driving control CTad by outputting commands for controlling the engine 12, the wheel brake device 56, the steering device 58 and the like, to the hybrid control unit 92 and the like, so as to automatically perform acceleration/deceleration and steering based on the set target driving state.

The autonomous driving that is driving in the autonomous driving control CTad includes a manned driving and an unmanned driving. The manned driving in the autonomous driving control CTad is a manned autonomous driving, and the unmanned driving in the autonomous driving control CTad is an unmanned autonomous driving.

Incidentally, since there is a passenger in the manned autonomous driving, the NV is more likely to be increased than in the unmanned autonomous driving, for example, when the engine 12 is controlled so as to achieve the optimum engine operating point. Therefore, the electronic control apparatus 90 increases the load of the engine 12 during execution of the unmanned autonomous driving to increase the state of charge SOC prior to start of the manned autonomous driving, thereby extending the period in which the BEV driving mode can be established and improving the quietness.

The charging control portion 94 performs an NV suppression control CTny in which the required charging power Pchgdem is set to a larger value during the unmanned autonomous driving than during the manned autonomous driving.

When it is determined the unmanned autonomous driving is to be switched to the manned autonomous driving, the charging control portion 94 performs the NV suppression control CTny in preparation for the manned autonomous driving.

The driving control portion 96 determines whether the unmanned autonomous driving is to be switched to the manned autonomous driving. For example, the driving control portion 96 may make this determination, depending on whether or not there is a passenger who rides at a next destination during execution of the unmanned autonomous driving. The next destination is, for example, a point or the like at which a passenger accepted by a boarding reservation or the like in an unmanned taxi rides on.

When the driving control portion 96 determines that the unmanned autonomous driving is to be switched to the manned autonomous driving in the autonomous driving control CTad, the charging control portion 94 performs the NV suppression control CTnv during the execution of the unmanned autonomous driving until the manned autonomous driving is started.

The charging control portion 94 acquires a travel distance Ddrv from a current point to a point at which the unmanned autonomous driving is switched to the manned autonomous driving during execution of the unmanned autonomous driving. In addition, the charging control portion 94 acquires the current state of charge SOCr which is the current value of the state of charge SOC during execution of the unmanned autonomous driving. The charging control portion 94 calculates the required charging power Pchgdem based on the travel distance Ddrv and the current state of charge SOCr during execution of the unmanned autonomous driving. For example, the charging control portion 94 calculates the required charging power Pchgdem by applying the travel distance Ddrv and the current state of charge SOCr to a predetermined NV priority execution map. The NV priority execution map is a map for prioritizing an improvement of the NV performance over an improvement of the fuel efficiency performance after the switching to the manned autonomous driving. The NV priority execution map is a predetermined relationship for setting the state of charge SOC at the start of the manned autonomous driving to a value greater than an upper limit value of the predetermined state-of-charge range RNGsoc, for example. That is, when the driving control portion 96 determines that the unmanned autonomous driving is to be switched to the manned autonomous driving, the charging control portion 94 performs the NV suppression control CTny so that the state of charge SOC when the manned driving is started becomes a value larger than the upper limit value of the predetermined state-of-charge range RNGsoc.

On the other hand, the charging control portion 94 controls the engine 12 such that the state of charge SOC is within the predetermined state-of-charge range RNGsoc and such that the energy efficiency of the vehicle 10 is optimized, during execution of the manned autonomous driving, or during execution of the unmanned autonomous driving without the driving control portion 96 determining that the unmanned autonomous driving is to be switched to the manned autonomous driving. The predetermined state-of-charge range RNGsoc and the optimum engine operating point are included in a fuel-efficiency optimum execution map for giving a priority to the improvement of the fuel efficiency. That is, the charging control portion 94 calculates the required charging power Pchgdem using the fuel-efficiency optimum execution map during execution of the manned autonomous driving, or during execution of the unmanned autonomous driving without the switching to the manned autonomous driving being determined by the driving control portion 96.

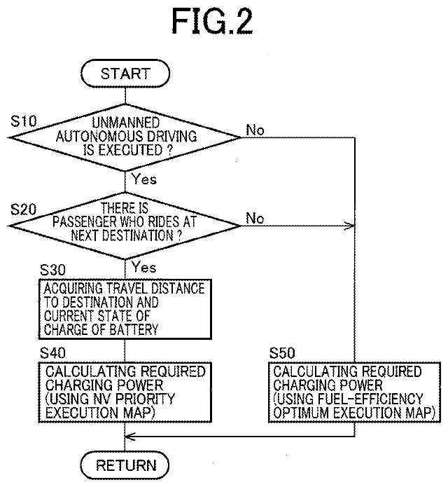

FIG. 2 is a flowchart illustrating a main part of a control operation of the electronic control apparatus 90, which is a flowchart illustrating a control operation for improving the NV performance in the autonomous driving, and is repeatedly executed, for example.

In FIG. 2, first, in step (hereinafter, step is omitted) S10 corresponding to the function of the driving control portion 96, it is determined whether or not the unmanned autonomous driving is being executed. When an affirmative termination is made in the S10, S20 corresponding to the function of the driving control portion 96 is implemented to determine whether or not there is any passenger who rides on the vehicle 10 at the next destination. When an affirmative determination is made in this S20, the travel distance Ddrv from the current point to the destination (the point at which the unmanned autonomous driving is switched to the manned autonomous driving) is acquired and the current state of charge (current remaining charge amount) SOCr is acquired in S30 corresponding to the function of the charging control portion 94. After this S30, in S40 corresponding to the function of the charging control portion 94, the required charging power Pchgdem is calculated using the NV priority execution map. On the other hand, when a negative determination is made in the S10 or in the S20, the required charging power Pchgdem using the fuel-efficiency optimum execution map is calculated in S50 corresponding to the function of the charging control portion 94.

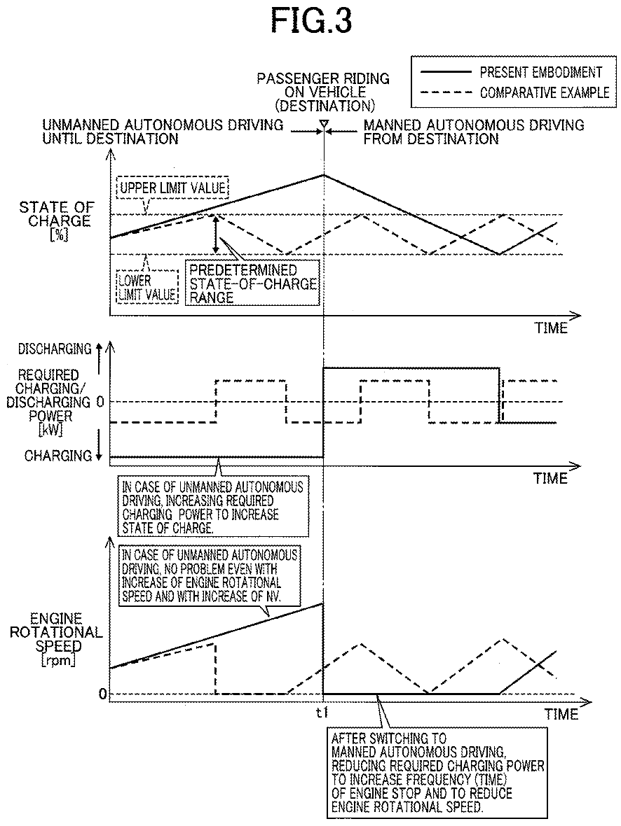

FIG. 3 is a diagram showing an example of a time chart when the control operation shown in the flowchart of FIG. 2 is executed. FIG. 3 illustrates an example of a case where autonomous driving is executed. A comparative example indicated by broken line shows an example of a case where the engine 12 is controlled such that the state of charge SOC is within the predetermined state-of-charge range RNGsoc and such that the energy efficiency of the vehicle 10 is optimized. In FIG. 3, a time point t1 is a time point at which a passenger rides on the vehicle 10 in a destination during execution of the unmanned autonomous driving, and is a time point at which the manned autonomous driving is started. As indicated by solid line, the required charging power Pchgdem in the unmanned autonomous driving is set to a value larger than the required charging power Pchgdem (see the broken line) using the fuel-efficiency optimum execution map until the time point t1. As a result, the state of charge SOC at the time point t1 is increased to be higher than the upper limit value of the predetermined state-of-charge range RNGsoc. Since the unmanned autonomous driving is performed until the time point t1, a problem is unlikely to occur even if the engine rotational speed Ne is increased and the NV is increased. After the start of the manned autonomous driving, the required charging power Pchgdem is reduced, the engine 12 is brought into its stopped state, and the BEV driving is executed. In the present embodiment, a frequency of stop of the engine 12 is increased and the engine rotational speed Ne is reduced as compared with the comparative example. Thereby, the NV performance is improved.

As described above, according to the present embodiment, the NV suppression control CTnv is performed during execution of the unmanned autonomous driving. As a result, the charging power Pchg is increased during execution of the unmanned autonomous driving in which increase of NV is less likely to be a problem, and the state of charge SOC upon start of the manned autonomous driving is increased compared to that during continuation of the manned autonomous driving. Therefore, in a period in which the state of charge SOC is large after the start of the manned autonomous driving that has been switched from the unmanned autonomous driving, the time during which the engine 12 is in the stopped state is increased or the engine rotational speed Ne is reduced. Therefore, the NV performance can be improved in the autonomous driving.

In addition, according to the present embodiment, when it is determined that the unmanned autonomous driving is to be switched to the manned autonomous driving, the NV suppression control CTnv is performed during the execution of the unmanned autonomous driving until the manned autonomous driving is started. As a result, the state of charge SOC upon start of the manned autonomous driving is appropriately increased as compared with that during the continuation of the manned autonomous driving.

Further, according to the present embodiment, in the NV suppression control CTnv, the required charging power Pchgdem is calculated based on the travel distance Ddrv and the current state of charge (current remaining charge amount) SOCr. Accordingly, the required charging power Pchgdem is appropriately set to a larger value during execution of the unmanned autonomous driving than during execution of the manned autonomous driving.

In addition, according to the present embodiment, during execution of the manned autonomous driving, or during execution of the unmanned autonomous driving without the driving control portion 96 determining that the unmanned autonomous driving is to be switched the manned autonomous driving, the engine 12 is controlled such that the state of charge SOC falls within the predetermined state-of-charge range RNGsoc and the fuel efficiency is optimized. Thus, the control that gives priority to the improvement of the fuel efficiency performance is appropriately executed.

Further, according to the present embodiment, when the driving control portion 96 determines that the unmanned autonomous driving is to be switched to the manned autonomous driving, the NV suppression control CTny is performed such that the state of charge SOC upon start of the manned driving becomes a value larger than the upper limit value of the predetermined state-of-charge range RNGsoc. Thus, the control that gives priority to the improvement of the NV performance is appropriately executed.

Although the embodiments of the present disclosure have been described in detail with reference to the drawings, the present disclosure is also applicable to other embodiments.

For example, in the above-described embodiment, in the NV suppression control CTny, the target value of the state of charge SOC upon start of the manned driving may be set in advance to a value larger than the upper limit value of the predetermined state-of-charge range RNGsoc. Then, in the NV suppression control CTny, the required charging power Pchgdem for increasing the current state of charge SOCr to the target value of the state of charge SOC may be calculated while the vehicle 10 runs for the travel distance Ddrv.

Further, in the above-described embodiment, the present disclosure can be applied to a parallel or series hybrid electric vehicle including an engine and an electric motor as power sources, a so-called plug-in hybrid electric vehicle in which a battery can be charged from an external power source such as a charging station or a household power source, or the like.

It should be noted that the above-described embodiment is merely one embodiment, and the present disclosure can be implemented in a mode in which various changes and improvements are added based on the knowledge of those skilled in the art.

### NOMENCLATURE OF ELEMENTS

10: vehicle (hybrid electric vehicle)
12: engine
54: battery
90: electronic control apparatus (control apparatus)
94: charging control portion
96: operation control portion
MG1: first motor (motor)
MG2: second motor (motor)

What is claimed is:

1. A control apparatus for a hybrid electric vehicle including an engine, an electric motor, and a battery that supplies and receives an electric power to and from the electric motor, the control apparatus comprising:
a driving control portion configured to execute an manual driving control for driving the vehicle based on a driving operation by a driver of the vehicle and an autonomous driving control for driving the vehicle by automatically performing steering and acceleration/deceleration of the vehicle; and
a charging control portion configured to perform an NV suppression control in which a required charging power for charging the battery with the electric power generated by the electric motor using a power of the engine, is set to a larger value during an unmanned driving in the autonomous driving control than during a manned driving in the autonomous driving control.

2. The control apparatus according to claim 1, wherein the charging control portion is configured, when the driving control portion determines that the unmanned driving is to be switched to the manned driving in the autonomous driving control, to perform the NV suppression control during execution of the unmanned driving until the manned driving is started.

3. The control apparatus according to claim 2, wherein the charging control portion is configured, during execution of the unmanned driving, to calculate the required charging power based on (i) a travel distance from a current point to a point at which the unmanned driving is switched to the manned driving and (ii) a current remaining charge amount of the battery.

4. The control apparatus according to claim 2, wherein the charging control portion is configured, during execution of the manned driving, or during execution of the unmanned driving without the driving control portion determining that the unmanned driving is to be switched to the manned driving, to control the engine such that a remaining charge amount of the battery is within a predetermined remaining charge amount range and such that an energy efficiency of the vehicle is optimized.

5. The control apparatus according to claim 4, wherein the charging control portion is configured, when the driving control portion determines that the unmanned driving is to be switched to the manned driving, to perform the NV suppression control such that the remaining charge amount upon start of the manned driving becomes a value larger than an upper limit value of the predetermined remaining charge amount range.
